(19) United States
(12) Patent Application Publication
(10) Pub. No.: US 2026/0326800 A1
(43) Pub. Date: Oct. 22, 2026

(54) Hand Truck Having Wheels With Integrated Hub Motors

(71) Applicant: Magline, Inc., Standish, MI (US)

(72) Inventors: Michael Casey, Bedford, NH (US); Kennedy Oparka, Bay City, MI (US); Chad David Winters, Bay City, MI (US)

(21) Appl. No.: 19/566,016

(22) Filed: Mar. 13, 2026

Related U.S. Application Data
(60) Provisional application No. 63/771,772, filed on Mar. 14, 2025.

(51) Int. Cl. B62B 1/10; B62B 5/00; B62B 5/04

(52) U.S. Cl. CPC B62B 1/10; B62B 5/004; B62B 5/0043; B62B 5/04

(57) ABSTRACT

A motorized hand truck that simplifies assembly, increases efficiency, and enhances user control through an integrated braking system. By incorporating the motor within the hub (104) of the wheel (102) itself, this design achieves improved performance while reducing the need for additional components, thereby offering a robust and practical solution for material handling applications.

### CROSS-REFERENCE TO RELATED APPLICATION

This application claims priority to U.S. Provisional Patent Application No. 63/771,772, filed on Mar. 14, 2025 the entire disclosure of which is hereby incorporated by reference in its entirety

### FIELD OF INVENTION

The present invention relates to hand trucks, and more particularly to a hand truck incorporating at least one motorized wheel, wherein the motor is disposed within the hub of the wheel assembly itself. This design enhances ground clearance, reduces assembly complexity and maintenance time, and simplifies the overall construction. The invention further integrates a braking functionality that allows a user to engage forward and reverse motion, wherein reverse motion serves as a braking mechanism to counteract forward motion, and vice versa.

### BACKGROUND

Traditional hand trucks rely on manual operation or external motorized drive systems, which can be bulky, complex to assemble, and prone to mechanical failures due to multiple interconnected components. The need exists for an improved design that integrates the motor within the hub of the wheel assembly itself, thereby streamlining construction, improving reliability, and enhancing ease of use. Additionally, conventional braking systems on motorized hand trucks often require separate components, adding to weight and complexity. There is a need for a braking mechanism that seamlessly integrates into the motorized system, reducing additional parts and failure points.

Accordingly, an improved method and systems for hand trucks with improved motor systems and assemblies are needed in the industry.

### SUMMARY

A motorized hand truck featuring at least one wheel with an integrated motor within the hub, eliminating the need for external drive linkages. This design results in increased ground clearance, reduced assembly and repair complexity, and an overall more efficient structure. Furthermore, the hand truck includes an innovative braking system wherein the motor can engage in reverse motion to counteract forward movement, thereby providing controlled deceleration without requiring additional braking mechanisms. This dual-motion functionality simplifies operation and enhances safety.

A motorized hand truck featuring at least one wheel with an integrated motor positioned directly within the hub is disclosed, thereby eliminating the need for external drive linkages and associated mounting hardware. By embedding the motor within the hub assembly, the design achieves increased ground clearance, reduces spatial footprint, and minimizes exposure of critical components to environmental hazards. This integrated configuration results in lower assembly complexity, fewer alignment requirements, and reduced incidence of mechanical failures, thereby simplifying both manufacturing and long-term maintenance.

In certain embodiments, the hand truck incorporates a unified control system that enables the user to selectively regulate forward propulsion and reverse torque generation. The innovative braking functionality leverages controlled reverse motor motion to decelerate the hand truck without relying on external friction-based braking components. This approach reduces system weight, eliminates additional wear-producing mechanisms, and provides precise, responsive braking behavior that enhances operator control and safety. The dual-motion capability—using the motor for both propulsion and braking—streamlines the mechanical architecture and supports a more efficient, intuitive user experience. Additionally, embodiments may include accelerators, brake switches, sensors, and a removable battery system configured to optimize balance, stability, and ease of operation. Overall, the integrated hub-motor design provides a compact, durable, and highly efficient solution for transporting loads across a variety of terrain conditions.

### BRIEF DESCRIPTION OF THE DRAWINGS

The operation of the invention may be better understood by reference to the detailed description taken in connection with the following illustrations, wherein:

FIG. 1 illustrates a perspective view of the hand truck with a wheel and hub having an integrated motor within the hub according to one or more embodiments shown and described herein;

FIG. 2 illustrates a rear view of the hand truck with a wheel and hub having an integrated motor within the hub according to one or more embodiments shown and described herein;

FIG. 3 illustrates a side view of the hand truck with a wheel and hub having an integrated motor within the hub according to one or more embodiments shown and described herein;

FIG. 4 illustrates a close up side view of the axle area (without the wheels) hand truck with a wheel and hub having an integrated motor within the hub according to one or more embodiments shown and described herein;

FIG. 5 illustrates a close up side view of the axle area (without the wheels) hand truck with a wheel and hub having an integrated motor within the hub according to one or more embodiments shown and described herein;

FIG. 6 illustrates a close up perspective view of the accelerator (no brake) of the hand truck with a wheel and hub having an integrated motor within the hub according to one or more embodiments shown and described herein;

FIG. 7 illustrates a close up perspective view of the accelerator (with a brake switch) of the hand truck with a wheel and hub having an integrated motor within the hub according to one or more embodiments shown and described herein;

FIG. 8 illustrates a close up perspective view of the accelerator (with a brake switch) of the hand truck with a wheel and hub having an integrated motor within the hub according to one or more embodiments shown and described herein;

FIG. 9 illustrates a cross-sectional view of the hub and motor of the hand truck with a according to one or more embodiments shown and described herein.

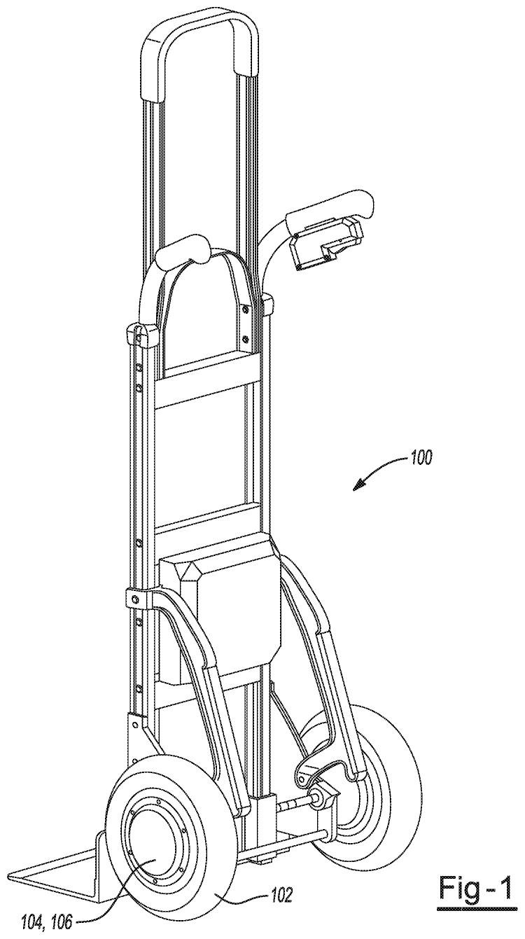

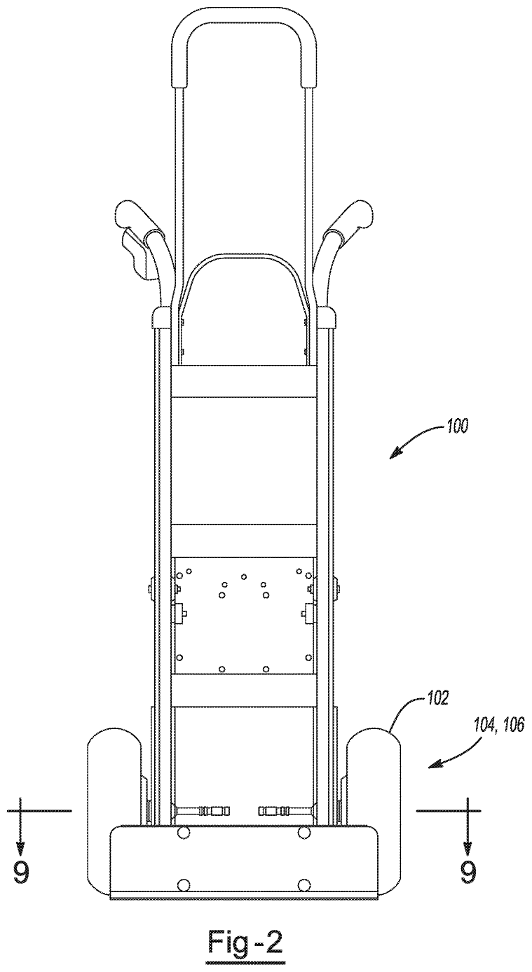

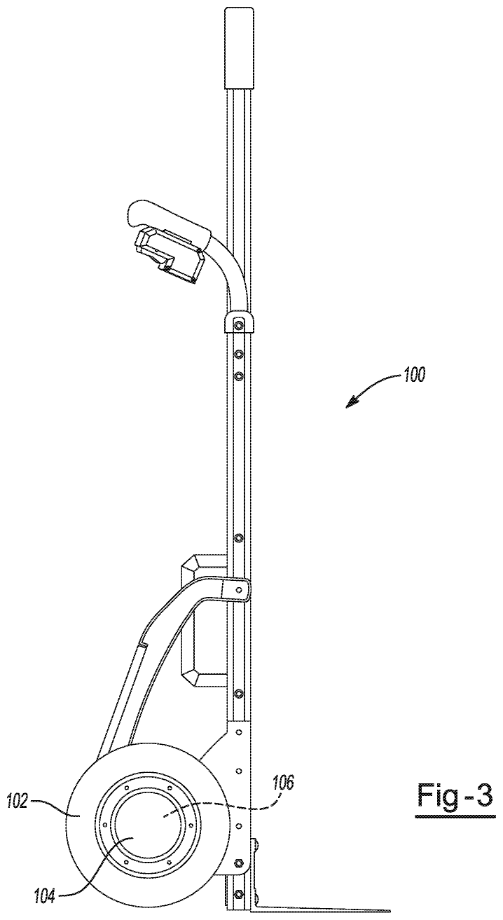

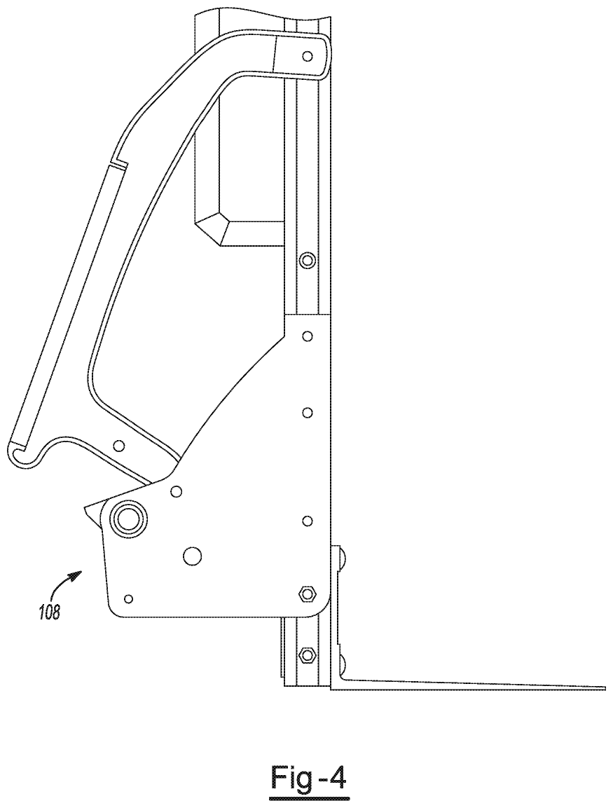

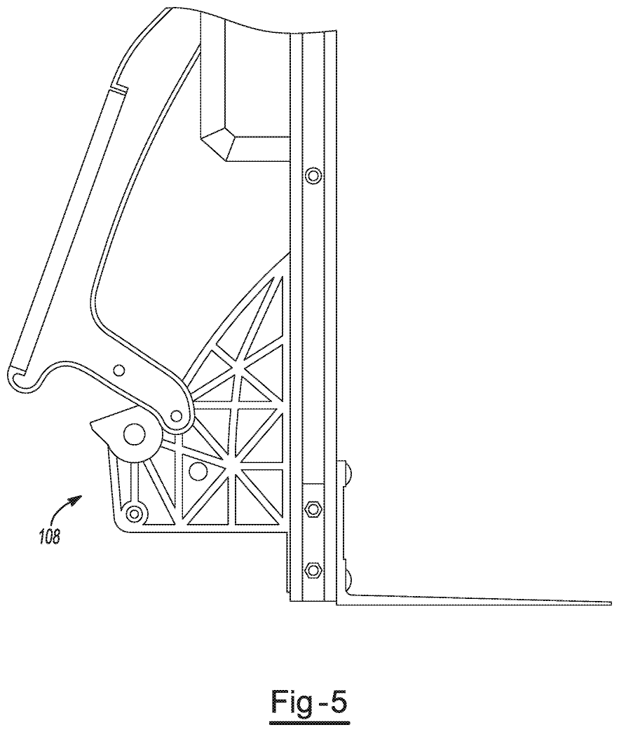

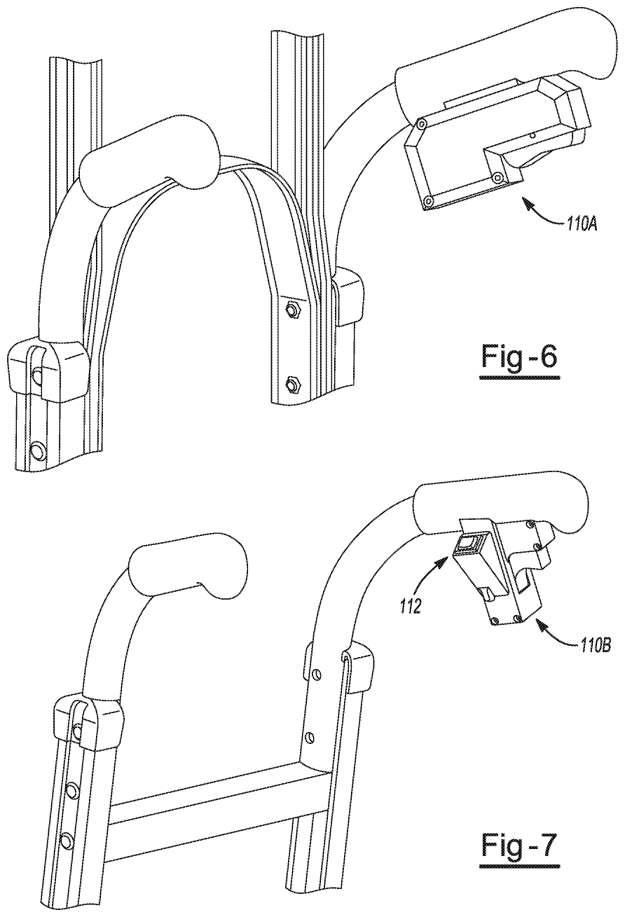

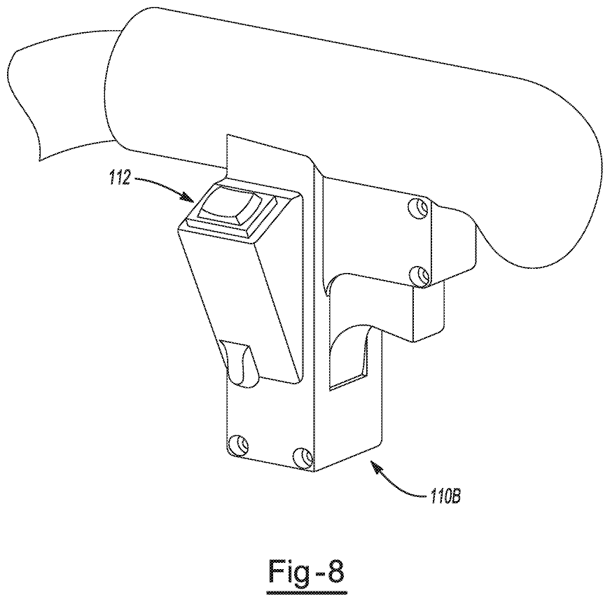

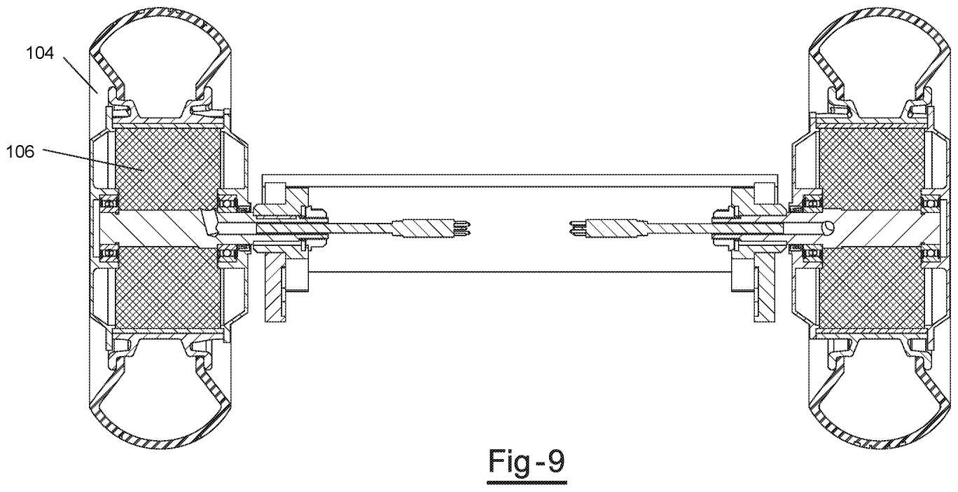

### DETAILED DESCRIPTION

Reference will now be made in detail to exemplary embodiments of the present invention, examples of which are illustrated in the accompanying drawings. It is to be understood that other embodiments may be utilized and structural and functional changes may be made without departing from the respective scope of the invention. Moreover, features of the various embodiments may be combined or altered without departing from the scope of the invention. As such, the following description is presented by way of illustration only and should not limit in any way the various alternatives and modifications that may be made to the illustrated embodiments and still be within the spirit and scope of the invention.

The hand truck 100 includes a frame 101 and a load-bearing platform 103 configured to support and transport cargo of various sizes. Mounted to the frame 101 is at least one motorized wheel 102, each wheel incorporating a motor 106 positioned directly within the hub 104 of the wheel assembly. This integrated hub-motor configuration eliminates the need for external drive mechanisms such as chains, belts, or gear assemblies, thereby reducing overall mechanical complexity and enabling a compact and streamlined structure. The axle 108 supports rotational engagement between the hub 104 and the frame 101 while maintaining alignment of the motorized wheel 102 during operation.

The motorized hand truck 100 consists of the frame 101, the load-bearing platform 103, at least one motorized wheel 102, the hub 104, the motor 106, and the axle 108. Unlike conventional designs, the motor 106 is housed within the hub 104 of the wheel 102 itself, leading to several advantages. In addition to these structural components, the arrangement of the frame 101, platform 103, motorized wheel 102, hub 104, motor 106, and axle 108 enables a compact and highly integrated configuration that improves overall system efficiency. By embedding the motor 106 directly within the hub 104, the design reduces the spatial footprint typically required for external mounting brackets, drive shafts, or belt-and-chain systems. This integration not only enhances durability by protecting critical motor elements from environmental exposure, but also allows for more balanced weight distribution across the hand truck 100, thereby improving stability during operation. Furthermore, the centralized motor placement facilitates smoother power transfer to the wheel 102, resulting in more responsive acceleration and a streamlined mechanical architecture that supports easier manufacturing and long-term reliability.

Increased Ground Clearance: By eliminating external drive linkages, the design improves maneuverability over obstacles and uneven terrain. This configuration allows the hand truck to traverse surfaces such as thresholds, gravel, debris, or uneven flooring with reduced risk of snagging or mechanical interference. The absence of protruding components beneath the chassis also minimizes the likelihood of impact damage during operation, thereby enhancing durability and extending service life. Additionally, the increased clearance contributes to smoother handling in confined or cluttered environments, enabling the user to maintain better control while transporting loads across variable terrain conditions.

Reduced Assembly Complexity and Time: The integrated motor within the hub simplifies the assembly process by removing the need for separate motor mounts and transmission components. This consolidation of parts not only reduces the number of steps required during manufacturing but also minimizes alignment challenges that typically arise when installing externally mounted motors and associated linkages. By incorporating the motor directly into the hub, the design decreases potential points of failure and streamlines quality-control procedures. Additionally, the reduced component count lowers inventory requirements and assembly labor, resulting in a more efficient and cost-effective production process while improving overall system reliability.

Simplified Maintenance: With fewer external mechanical parts, breakdowns are minimized, and repairs are straightforward. By integrating the motor within the wheel hub, the design eliminates many of the traditional components—such as belts, chains, external gear assemblies, and mounting brackets—that typically require periodic adjustment or replacement. This reduction in exposed moving parts significantly decreases wear caused by dirt, debris, and environmental exposure. When servicing is required, technicians can access key components more easily due to the consolidated structure, resulting in faster diagnostics and reduced downtime. Overall, the streamlined architecture enhances long-term reliability and lowers total maintenance costs.

Integrated Braking Functionality: In one embodiment, the control system includes an accelerator 110A for forward motion and reverse motion (thereby negating the need for a brake). In a separate embodiment, the control system includes a forward accelerator 110B for reverse motion, and a brake switch 112 to engage the braking function. The system allows the user to toggle between forward and reverse motion, with reverse motion serving as a braking mechanism to decelerate forward motion, and vice versa. This feature eliminates the need for traditional braking components, reducing overall system weight and complexity. In addition to these embodiments, the integrated braking functionality provides significant operational benefits by streamlining user interaction and reducing mechanical dependency on conventional braking hardware. By leveraging the motor's capability to generate controlled reverse torque, the system delivers precise and proportional deceleration without introducing additional friction-based components that traditionally require regular adjustment or replacement. This electronic approach to braking allows for smoother transitions between motion states, improves overall stability during load handling, and enhances safety by providing immediate response to user inputs. Furthermore, consolidating propulsion and braking into a unified control architecture minimizes wiring complexity, reduces potential points of mechanical failure, and supports a more compact and efficient design suitable for a wide range of hand-truck configurations.

The control system includes a user interface for speed regulation and braking engagement, utilizing the forward accelerator and a reverse accelerator, and brake switch 112 (if only a forward accelerator) to ensure precise handling of the hand truck 100. The system may include sensors to detect user input and adjust motor power accordingly.

The motorized hand truck of the present invention features a streamlined design that incorporates several key elements, including a frame, a load-bearing platform, motorized wheels, a hub, a motor, and an axle. This innovation differentiates itself from traditional hand trucks by integrating the motor directly into the hub of the wheel, which brings multiple benefits to the overall design.

One of the primary advantages of this integrated motor system is increased ground clearance. By eliminating the need for external drive linkages, the design enhances the hand truck's maneuverability, allowing it to easily navigate over obstacles and uneven terrain without obstruction. This makes it particularly well-suited for environments where smooth, obstacle-free movement is essential.

Additionally, the integration of the motor within the wheel hub significantly reduces the complexity of assembly. With fewer components required, the assembly process becomes faster and more efficient. The elimination of separate motor mounts and transmission components means fewer parts to handle, ultimately reducing both time and cost during production.

Another notable benefit is simplified maintenance. The lack of external mechanical parts not only minimizes the risk of breakdowns but also ensures that repairs, when necessary, are more straightforward. The design minimizes the need for complex maintenance routines, allowing users to focus on operation rather than constant upkeep.

In terms of control functionality, the motorized hand truck features an integrated braking system. The control system consists of two accelerators, one for forward motion and one for reverse motion, along with a brake switch that engages the braking mechanism. This system enables the user to toggle between forward and reverse motion with ease. When the hand truck is moving forward, the reverse accelerator functions as a braking mechanism to slow or stop the movement, while the forward accelerator provides propulsion. This dual-use functionality eliminates the need for traditional braking components, reducing the overall weight and complexity of the system.

The control system also includes a user interface designed to regulate speed, power, torque, throttle, and/or braking. By using the accelerators and brake switch, the user has precise control over the hand truck's movements. Additionally, the system may incorporate sensors that detect user input and adjust the motor power, speed, torque, and/or throttle (and thus braking) accordingly, ensuring that the hand truck responds intuitively to the user's commands, enhancing both ease of use and safety. The control system may use speed, power, torque, and/or throttle data and/or information to implement a reverse force on the motor to effectuate a braking effect on the system (without actually applying a traditional user brake).

The system may also include a removable battery whereby the battery is utilized to power the motor and controls of the system. The battery may be positioned and mounted so to optimize the center of gravity thereby making the overall assembly more stable and balanced. The removable battery is made removable to optimize ease of charging and to allow for easy replacement of batteries. The positioning of the removable battery must be accessible and also optimized for balance and center of gravity of the overall system.

Although the embodiments of the present invention have been illustrated in the accompanying drawings and described in the foregoing detailed description, it is to be understood that the present invention is not to be limited to just the embodiments disclosed, but that the invention described herein is capable of numerous rearrangements, modifications and substitutions without departing from the scope of the claims hereafter. The claims as follows are intended to include all modifications and alterations insofar as they come within the scope of the claims or the equivalent thereof.

It is noted that the terms “substantially” and “about” may be utilized herein to represent the inherent degree of uncertainty that may be attributed to any quantitative comparison, value, measurement, or other representation.

These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter.

Unless otherwise stated, any numerical values recited herein include all values from the lower value to the upper value in increments of one unit provided that there is a separation of at least 2 units between any lower value and any higher value. As an example, if it is stated that the amount of a component, a property, or a value of a process variable such as, for example, temperature, pressure, time and the like is, for example, from 1 to 90, preferably from 20 to 80, more preferably from 30 to 70, it is intended that intermediate range values such as (for example, 15 to 85, 22 to 68, 43 to 51, 30 to 32 etc.) are within the teachings of this specification. Likewise, individual intermediate values are also within the present teachings. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight. Thus, an expression in the Detailed Description of the Invention of a range in terms of at “‘x’ parts by weight of the resulting polymeric blend composition” also contemplates a teaching of ranges of same recited amount of “x” in percent by weight of the resulting polymeric blend composition.”

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The term “consisting essentially of” to describe a combination shall include the elements, ingredients, components, or steps identified, and such other elements ingredients, components or steps that do not materially affect the basic and novel characteristics of the combination. The use of the terms “comprising” or “including” to describe combinations of elements, ingredients, components, or steps herein also contemplates embodiments that consist essentially of, or even consist of the elements, ingredients, components or steps.

Plural elements, ingredients, components, or steps can be provided by a single integrated element, ingredient, component or step. Alternatively, a single integrated element, ingredient, component, or step might be divided into separate plural elements, ingredients, components or steps. The disclosure of “a” or “one” to describe an element, ingredient, component, or step is not intended to foreclose additional elements, ingredients, components or steps. All references herein to elements or metals belonging to a certain group refer to the Periodic Table of the Elements published and copyrighted by CRC Press, Inc., 1989. Any reference to the group or groups shall be to the group or groups as reflected in this Periodic Table of the Elements using the IUPAC system for numbering groups.

While particular embodiments have been illustrated and described herein, it should be understood that various other changes and modifications may be made without departing from the spirit and scope of the claimed subject matter.

Moreover, although various aspects of the claimed subject matter have been described herein, such aspects need not be utilized in combination.

It is therefore intended that the appended claims (and/or any future claims filed in any utility application) cover all such changes and modifications that are within the scope of the claimed subject matter.

Moreover, although various aspects of the claimed subject matter have been described herein, such aspects need not be utilized in combination.

It is therefore intended that the appended claims cover all such changes and modifications that are within the scope of the claimed subject matter. Having thus described the invention, we claim:

1. A hand truck comprising:
a frame and a load-bearing platform;
at least one wheel having an integrated motor disposed within the hub of the wheel assembly;
a control system configured to regulate motor operation; and
a braking functionality wherein the motor reverses motion to decelerate forward movement.

2. The hand truck of claim 1, wherein the integrated motor within the hub eliminates external drive linkages, increasing ground clearance and reducing mechanical complexity.

3. The hand truck of claim 1, wherein the braking functionality eliminates the need for separate braking components by utilizing reverse motor motion for deceleration.

4. The hand truck of claim 1, further comprising a user interface to control speed, forward motion, and reverse braking.

5. The hand truck of claim 1, wherein the motorized wheel is configured to provide controlled acceleration and deceleration to enhance safety and usability.

6. A hand truck comprising:
a frame and a load-bearing platform; and
at least one wheel having an integrated motor disposed within the hub of the wheel assembly.

7. The a hand truck of claim 6, wherein the hand truck further includes a control system configured to regulate motor operation; and
a braking functionality wherein the motor reverses motion to decelerate forward movement.

8. The hand truck of claim 6, wherein the integrated motor within the hub eliminates external drive linkages, increasing ground clearance and reducing mechanical complexity.

9. The hand truck of claim 7, wherein the braking functionality eliminates the need for separate braking components by utilizing reverse motor motion for deceleration.

10. The hand truck of claim 7, further comprising a user interface to control speed, forward motion, and reverse braking.

11. The hand truck of claim 6, wherein the motorized wheel is configured to provide controlled acceleration and deceleration to enhance safety and usability.
